(19) United States
(12) Patent Application Publication
(10) Pub. No.: US 2024/0307961 A1
(43) Pub. Date: Sep. 19, 2024

(54) LIGHTWEIGHT CORROSION-RESISTANT WEAR-RESISTANT BRAKE DISC, AND METHOD OF MANUFACTURING

(71) Applicant: OERLIKON METCO (US) INC., Westbury, NY (US)

(72) Inventor: Cameron Jacob EIBL, Encinitas, CA (US)

(73) Assignee: OERLIKON METCO (US) INC., Westbury, NY (US)

(21) Appl. No.: 18/268,520

(22) PCT Filed: Dec. 20, 2021
(86) PCT No.: PCT/US2021/064393

§ 371 Date: Jun. 20, 2023

Related U.S. Application Data
(60) Provisional application No. 63/128,516, filed on Dec. 21, 2020.

(51) Int. Cl. B22F 7/08; B22F 9/02; B22F 9/08; B23P 15/00; F16D 65/00; F16D 65/02; F16D 65/12; F16D 69/04

(52) U.S. Cl. CPC B22F 7/08; B23P 15/00; F16D 65/0025; F16D 65/127; F16D 69/04; B22F 9/026; B22F 9/082; B22F 2301/35; B22F 2302/253; B22F 2304/10; B22F 2998/10; F16D 2065/132; F16D 2069/0458; F16D 2069/0491; F16D 2200/0017; F16D 2200/003; F16D 2200/0047; F16D 2250/0076

(57) ABSTRACT

A method of manufacturing a corrosion- and wear-resistant component and a corrosion- and wear-resistant component. The method includes preparing a feedstock powder that includes a stainless steel powder and a ceramic powder, sintering the feedstock powder at a first temperature to form a low porosity free-standing wear body, and bonding the wear body to an aluminum or aluminum alloy substrate at a second temperature lower than the first temperature.

### CROSS-REFERENCE TO RELATED APPLICATION

This application claims the benefit and priority under 35 U.S.C § 119 of U.S. Provisional Application No. 63/128,516 filed Dec. 21, 2020, the disclosure of which is expressly incorporated by reference herein in its entirety.

### BACKGROUND

### 1. Field of the Disclosure

This technology generally relates to methods and systems for a lightweight corrosion-resistant and wear-resistant component, and methods of manufacturing thereof. In particular, example embodiments relate to lightweight corrosion-resistant wear-resistant coating for disc brakes, and methods of manufacturing.

### 2. Background Information

The current trend in mobility includes an increasing level of electrification and subsequent use of regenerative braking to reduce vehicle velocity and recapture kinetic energy for future use. Because regenerative braking is becoming increasingly sophisticated, conventional friction braking methods, such as brake discs, are less relied upon in daily operation and instead are used for only part of the braking process and/or for emergency braking. As a result, high heat capacity brake discs that can dissipate the heat produced from friction during repeated operation are not needed as much for many vehicles. This allows for new design possibilities for lighter weight brake discs. Another result of less frequent braking is the increased concern about corrosion of cast iron discs, as infrequent braking does not constantly remove the corrosion products on the wear surface. High levels of corrosion products on the surface of the disc can result in suboptimal braking performance and excessive fine particulate generation, both of which pose a safety hazard.

In addition, there is strong pressure from regulators and consumers to have more energy-efficient vehicles. One of the key drivers of energy efficiency is vehicle weight, with lower weights resulting in increased energy efficiency. Particularly, a lower unsprung and rotating weight increases energy efficiency, the unsprung weight being the weight of components such as, e.g., the suspension system, wheels, braking system, and the like, which are not supported by the suspension system of the vehicle. One pathway to reduce vehicle weight is to reduce the weight of the braking system. As a major component of the braking system, the brake disc is an attractive candidate for unsprung weight reduction.

Conventional brake disc materials are generally manufactured from cast iron having a density of about 7.8 g/cm³. If aluminum, with a density of about 2.7 g/cm³, can be substituted for some or all of the gray cast iron used in a brake disc, significant weight savings can be achieved. Further, aluminum has a relatively low cost compared to other light weight alternatives such as carbon composites, which are significantly more expensive. The challenge with aluminum as a brake disc material is that, in spite of good structural properties, low density and low cost, the wear properties of aluminum, when exposed to braking friction, are suboptimal.

### SUMMARY

Therefore, there is a need for replacing the wear surface of a disc brake with a material that is light, i.e., having a density that is less than that of gray iron (7.5 g/cm³), has sufficient toughness, and is wear resistant. For example, composites including stainless steel and ceramic, and especially metal matrix composites (MMC), may be good candidates.

To successfully use an MMC as the functional wear surface of a disc brake, several additional constraints must be taken into account. First, regulatory pressure precludes the use of wear materials comprising nickel due to health and environmental concerns. Second, a high level of corrosion resistance is needed to avoid poor appearance, shortened lifetime, or excessive particulate generation of the wear surface due to corrosion and the corrosion products generated therefrom. Third, the melting temperatures of aluminum and stainless steels are very different. Fourth, there is a trade-off required between toughness/ductility, which contributes to reducing or eliminating cracking, and wear resistance of the wear surface, which contributes to having a high number of wear cycles before replacement. Finally, bonding of dissimilar materials presents a challenge.

Example embodiments relate to methods and systems for a lightweight corrosion-resistant and wear-resistant component, and methods of manufacturing thereof. In particular, example embodiments relate to a method of manufacturing a lightweight corrosion- and wear-resistant component, the method including preparing a feedstock powder that includes a stainless steel powder and a ceramic powder; sintering the feedstock powder at a first temperature to form a low porosity free-standing wear body; and bonding the wear body to an aluminum or aluminum alloy substrate at a second temperature lower than the first temperature.

The example embodiments of this disclosure describe a method of manufacturing a brake disc that combines the corrosion performance of nickel-free stainless steel, the wear properties of an MMC with a ceramic phase, and the lightweight properties of aluminum in order to solve or sufficiently address the challenges described above.

In example embodiments, the following disclosure describes a method of manufacture of lightweight brake discs configured to be used under braking conditions that require the use of a wear surface with a melting temperature that is greater than 700° C.

Specifically, this disclosure describes manufacturing a composite, or blended powder, containing both a ceramic and a stainless steel, sintering the powder to form a dense wear body with suitable properties as discussed above at a first temperature, and subsequently bonding the wear body to an aluminum substrate at a second temperature that is lower than the first temperature used in the initial sintering of the wear body.

Manufacture of a powder comprising both stainless steel and ceramic allows for an eventual braking surface with improved wear resistance compared to a stainless steel powder without a ceramic phase. A pure ceramic may not have the toughness and ductility required for the end application and may not readily bond to the aluminum substrate. The use of a powder feedstock allows for sintering of a relatively homogeneous wear surface with minimal degradation of the ceramic phase. Such degradation would be expected via casting or similar high temperature processes where the wear body feedstock material goes through a molten or partially molten state during the formation of the wear body. Powder manufacture as an initial process further allows for balancing and tailoring the properties of the material by controlling the fraction, composition, and distribution of each component in the material.

An initial sintering process to form the wear body as a free-standing object from the feedstock powder allows the selection of optimized processing conditions, ideally suited to form a dense wear body with the properties needed for the end application. These properties include low porosity, good bonding between powder particles, good bonding between ceramic and stainless steel phases, and rapid processing for attractive economics. Such processing conditions may include first temperatures above the melting point of aluminum and may be performed above atmospheric pressure.

In a second manufacturing process, the free-standing sintered wear body is bonded to the aluminum substrate to form a brake disc, or a component that can be further processed to be usable as a brake disc. The use of a separate bonding process permits the use of processing conditions that are suitable or ideal for bonding the dissimilar materials of the wear body and the aluminum substrate. If sintering is used as the bonding method, the processing conditions must be controlled such that the formation of aluminide intermetallic is minimized while still ensuring that bonding is sufficient to avoid failure during use. Other processing conditions to be considered are the melting point of the aluminum substrate. The melting point of aluminum is below 660° C. for most or all aluminum alloys, necessitating a lower processing temperature than used in forming the initial wear body, referred to above as first temperatures. Any other bonding method, such as brazing or the use of adhesives, may also be conducted at a low enough temperature that the aluminum substrate would not melt, or have the mechanical properties thereof excessively degraded.

Embodiments are directed to a method of manufacturing a corrosion- and wear-resistant component. The method includes preparing a feedstock powder that includes a stainless steel powder and a ceramic powder; sintering the feedstock powder at a first temperature to form a low porosity free-standing wear body; and bonding the wear body to an aluminum or aluminum alloy substrate at a second temperature lower than the first temperature.

According to embodiments, the feedstock powder can be prepared using a spray drying process to form agglomerated powder particles containing the stainless steel powder and the ceramic powder.

According to other embodiments, the feedstock powder can be prepared via atomization. In embodiments, ceramic phases can precipitate during solidification or can be injected prior to solidification.

In accordance with embodiments, the feedstock powder may include between 10 vol % and 60 vol % ceramic with a D50 particle size between 5 and 40 μm.

In accordance with other embodiments, the first temperature can be greater than 900° C. The sintering can include Spark Plasma Sintering, Field Assisted Sintering, or Direct Current Sintering.

In accordance with embodiments, the second temperature can be below 650° C.

In accordance with other embodiments, the stainless steel powder may include ferritic stainless steel having a pitting resistance equivalent number (PREN) that is greater than or equal to 15, where PREN can be defined as, in wt %, Cr+3.3(Mo+0.5*W)+16*N.

According to other embodiments, the ceramic powder may include more than 80 wt % Al₂O₃.

In accordance with other embodiments, the stainless steel powder may include a microstructure with greater than 90 vol % ferrite, the stainless steel powder can include less than 0.5 wt % Nickel, and the feedstock powder can include less than 15 wt % Aluminum.

According to still other embodiments, the ceramic powder may constitute between 15 and 60 vol % of the free-standing wear body.

In accordance with still other embodiments, the free-standing wear body can have less than 5 vol % porosity after the bonding.

In embodiments, the free-standing wear body may be bonded to the aluminum or aluminum alloy substrate by a metallurgical bond.

In still other embodiments, in bonding the wear body to the substrate, an aluminide layer can be formed between the wear body and substrate, and the aluminide layer may be less than 25 μm thick.

According to other embodiments, the stainless steel can include a microstructure with greater than 90 vol % ferrite, and the composition may include less than 0.5 wt % Nickel and less than 15 wt % Aluminum.

In accordance with still yet other embodiments, a component can be manufactured by the above-described embodiments of the method. The component may be a brake disc of a motorized or of a non-motorized vehicle.

### BRIEF DESCRIPTION OF THE DRAWINGS

The present disclosure is further described in the detailed description that follows, in reference to the noted plurality of drawings, by way of non-limiting examples of preferred embodiments of the present disclosure, in which like characters represent like elements throughout the several views of the drawings.

FIG. 1 is a flowchart illustrating a method of manufacturing a lightweight, corrosion- and wear-resistant component, according to an example embodiment;

FIG. 2 is a scanning electron microscopy (SEM) micrograph of a ferritic stainless steel and ceramic, according to an example embodiment;

FIG. 3 is a SEM micrograph of a ferritic stainless steel and ceramic, according to another example embodiment;

FIG. 4 is a SEM micrograph of a wear body, according to an example embodiment; and

FIG. 5 is a SEM micrograph of a wear body, according to another example embodiment.

### DETAILED DESCRIPTION

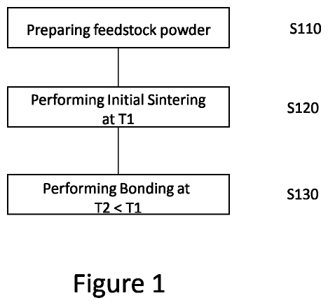

FIG. 1 is a flowchart illustrating a method of manufacturing a lightweight, corrosion- and wear-resistant component, according to an example embodiment. In FIG. 1, the method starts at S110, where a powder feedstock is prepared.

### 1. Feedstock Powder Used to Configure the Wear Body

Embodiments of this disclosure include a powder feedstock having a stainless steel component and one or more ceramic components processed to form a brake disc surface. In example embodiments, it may be advantageous to have a powder that comprises at least a certain fraction of ceramic to provide wear performance, but not more than a maximum fraction in order to ensure sufficient ductility.

In example embodiments, the powder may include, by volume percent, 10% to 60% ceramic phase. In example embodiments, the powder may include by volume percent 15% to 50% ceramic phase. In other example embodiments, the powder may include by volume percent 20% to 45% ceramic phase. In further example embodiments, the powder may include by volume percent 25% to 45% ceramic phase. In still further example embodiments, the powder may include by volume percent 30% to 40% ceramic phase. In still further example embodiments, the type of ceramic may allow to control cost, specific weight, thermal stability, toughness, or other properties. In example embodiments, if the powder includes more than 60% ceramic phase, then the ductility of the resulting component, e.g., the brake disc surface, decreases. In example embodiments, if the powder includes more than 60% ceramic phase, then both the ductility and the toughness of the resulting component, e.g., the brake disc surface, decrease.

In example embodiments, the ceramic phase in the powder may include greater than 80 wt % Al₂O₃. In other example embodiments, the ceramic phase in the powder may include Al₂O₃ and TiO₂. In further example embodiments, the ceramic phase in the powder may include, by weight percent, greater than 90% Al₂O₃ and less than 10% TiO₂. In still further example embodiments, the ceramic phase in the powder may include TiC. In other example embodiments, the ceramic phase in powder may include SiC. In further example embodiments, the ceramic phase in the powder may include a carbide of chromium. In still further example embodiments, the ceramic phase in the powder may include a carbide of chromium and iron. In still further example embodiments, the ceramic phase may include a boride of iron, chromium, molybdenum, and/or tungsten. In other example embodiments, the ceramic phase may include a boride of iron and chromium.

In example embodiments, the powder may have a true density, which is the density of the powder particles that make up the powder that is less than 7 g/cm³ in order to reduce the weight of the final component.

In example embodiments, the size of the ceramic in the feedstock powder may be important to control the wear and friction properties of the wear surface. In example embodiments, the powder size may be measured with a light laser scattering method analysis made in accordance with ASTM B822.

In example embodiments, the ceramic phase in the powder may have a D50, or median size distribution, between 5 μm and 40 μm. In other example embodiments, the ceramic phase in the powder may have a D50 between 5 μm and 30 μm. In further example embodiments, the ceramic phase in the powder may have a D50 between 5 μm and 25 μm. In still further example embodiments, the ceramic phase in the powder may have a D50 between 10 μm and 25 μm. In example embodiments, the ceramic phase in the powder may have a D50 between 2 μm and 20 μm. In example embodiments, when the D50 is greater than 40 μm or smaller than 5 μm, the wear performance of the component, e.g., the disc brake surface, degrades.

In example embodiments, the corrosion properties of the stainless steel component may be very important. Pitting resistance equivalent number (PREN) and/or Cr content are good predictors of the corrosion properties of a stainless steel alloy and composites of the alloys. PREN is defined, in wt %, as [Cr+3.3(Mo+0.5*W)+16*N].

In example embodiments, the stainless steel component of the powder may include a PREN that is greater than 15 and less than 50. In other example embodiments, the stainless steel component of the powder may include a PREN that is greater than 17. In further example embodiments, the stainless steel component of the powder may include a PREN that is greater than 20. In still further example embodiments, the stainless steel component of the powder may include a PREN that is greater than 23.

In example embodiments, the stainless steel component of the powder may include greater than 15 weight percent (wt %) and less than 32 wt % Chromium. In other example embodiments, the stainless steel component of the powder may include greater than 17 wt % and less than 32 wt % Chromium.

In example embodiments, the stainless steel component of the powder may include a ferritic BCC structure to provide improved toughness (versus a martensitic structure) and improved galling resistance (compared to an austenitic structure).

Because of regulatory, environmental, and safety concerns, nickel may be limited in most or all wear surfaces. Example embodiments of this disclosure specifically limit the nickel content of the feedstock powder.

In example embodiments, the stainless steel component of the powder may include less than 5 wt % Ni. In other example embodiments, the stainless steel component of the powder may include less than 3 wt % Ni. In further example embodiments, the stainless steel component of the powder may include less than 2 wt % Ni. In still further example embodiments, the stainless steel component of the powder may include less than 1.5 wt % Ni. In other example embodiments, the stainless steel component of the powder may include less than 1 wt % Ni. In further example embodiments, the stainless steel component of the powder may include less than 0.5 wt % Ni. In still further example embodiments, the stainless steel component of the powder may include less than 0.2 wt % Ni. In other example embodiments, the stainless steel component of the powder may include less than 0.1 wt % Ni.

To further decrease the weight of the brake disc, the alloy may contain aluminum to reduce the alloy density. At high aluminum content, embrittling aluminide phases may form.

In other example embodiments, the feedstock powder that includes stainless steel may also include between 1 wt % and 16 wt % Aluminum. In further example embodiments, the feedstock powder that includes stainless steel also includes between 1 wt % and 12 wt % Aluminum. In still further example embodiments, the feedstock powder that includes stainless steel also includes between 1 wt % and 10 wt % Aluminum. In other example embodiments, the feedstock powder that includes stainless steel also includes between 1 wt % and 8 wt % Aluminum. In further example embodiments, the feedstock powder that includes stainless steel also includes between 1 wt % and 6 wt % Aluminum.

The feedstock powder may be manufactured by blending to evenly distribute the ceramic and stainless steel components ensuring that a substantially homogeneous wear body is formed after sintering. More sophisticated manufacturing methods, such as agglomerating (e.g., via spray drying) or atomization, confer additional advantages in the form of further control of the type or types of ceramic present and by improving homogeneity of the ceramic particle distribution in the sintered wear body.

In example embodiments, the feedstock powder may be manufactured by blending separate ceramic and stainless steel powders. In other example embodiments, the feedstock powder may be manufactured by spray drying ceramic and stainless steel powders to form an agglomerated powder with an average size that is larger than the sizes of each of the separate powders. In further example embodiments, the powder agglomerated via spray drying may be partially sintered to improve processing and stability during transport and subsequent production of the wear body. In still further example embodiments, the feedstock powder may be manufactured by atomization with the ceramic phase precipitating in situ during atomization or being injected during or just prior to atomization of the molten metallic component.

In FIG. 1, after preparing the feedstock powder at S110, an initial sintering step of the powder is performed at S120 in order to form the wear body. During this step, the initial sintering step coalesces the feedstock powder of stainless steel and ceramic into a wear body that is to be further processed in order to form a brake disc.

In order to form a high density wear body with sufficient bonding between the feedstock powders and different phases in addition to low processing times, a certain minimum sintering temperature is desirable.

In example embodiments, the feedstock powder is sintered at a temperature that is above 900° C. In other example embodiments, the feedstock powder is sintered above 950° C. In further example embodiments, the feedstock powder is sintered above 1000° C. In still further example embodiments, the feedstock powder is sintered above 1050° C. In example embodiments, the feedstock powder is sintered above 1100° C. In other example embodiments, the feedstock powder is sintered above 1125° C.

In example embodiments, if the sintering temperature is less than 900° C., poor bonding between the particles and incomplete sintering may occur.

In example embodiments, the sintered wear body should be near the eventual shape of the wear surface on the brake disc to reduce further processing.

In example embodiments, the feedstock powder is sintered to form a wear body in a shape near the final surface dimensions of the brake disc wear surface. In other example embodiments, the shape has an outer diameter that is close to the final outer diameter of the brake disc and an inner diameter close to the inner limits of the eventual brake disc to be manufactured.

In order to form a high density wear body with sufficient bonding between the feedstock powders and different phases in addition to low processing times, a certain minimum pressure may be required. Pressure may be limited to a certain maximum by the strength of the ceramic phases and/or the processing equipment limitations.

In example embodiments, the feedstock powder is sintered between 10 MPa and 100 MPa. In other example embodiments, the feedstock powder is sintered between 10 MPa and 80 MPa. In further example embodiments, the feedstock powder is sintered between 25 MPa and 75 MPa. In still further example embodiments, the feedstock powder is sintered between 25 MPa and 60 MPa. In example embodiments, if the feedstock powder is sintered at a pressure that is less than 10 MPa, poor bonding between the particles and incomplete sintering may occur.

The sintering method used to form the wear body may be relevant to certain methods to provide improved economics or material properties. In example embodiments, the feedstock powder is sintered into the wear body using spark plasma sintering (SPS). This process may be referred to as field assisted sintering (FAST) or direct current sintering (DCS). In example embodiments, the SPS process may include additional secondary heating methods.

Porosity is an important indicator of the mechanical and wear properties of a material. Minimizing porosity, as measured either via a percentage of theoretical density or via quantitative microscopy, is desirable in ensuring good performance. In example embodiments, the feedstock powder is sintered into a wear body with less than 10% porosity by volume. In other example embodiments, the sintered wear body includes less than 5% porosity by volume. In further example embodiments, the sintered wear body includes less than 2% porosity by volume. In example embodiments, if the wear body has a porosity that is greater than 10%, the wear body may have a weight that may have an adverse impact such as increasing the unsprung weight and thus decreasing energy efficiency.

In example embodiments, the wear body has no cracking after sintering as cracking would be indicative of poor toughness and/or ductility of the wear body. Cracking may further present issues in subsequent processing or field performance.

In example embodiments, the density of the sintered wear body is less than 7.5 g/cm³ and greater than 2.0 g/cm³. In other example embodiments, the density of the sintered wear body is less than 7 g/cm³ and greater than 2.0 g/cm³. In further example embodiments, the density of the sintered wear body is less than 6.5 g/cm³ and greater than 2.0 g/cm³. In still further example embodiments, the density of the sintered wear body is less than 6 g/cm³ and greater than 2.0 g/cm³.

While the powder includes a fraction of ceramic phase, further processing may result in undesirable degradation of the ceramic phase in the wear body. As a result, it may be advantageous to ensure a certain minimum volume fraction of ceramic in the sintered material. In other example embodiments, the wear body after sintering may include a volume percent 10% to 60% ceramic phase. In further example embodiments, the wear body after sintering may include a volume percent 15% to 50% ceramic phase. In still further example embodiments, the wear body after sintering may include volume percent 20% to 45% ceramic phase. In other example embodiments, the wear body after sintering may include volume percent 20% to 30% ceramic phase.

In FIG. 1, subsequent to the initial sintering step, a bonding step is performed at S130. During this step, the wear body is joined to an aluminum substrate. Embodiments of this disclosure include a bonding step where the sintered free-standing wear body formed from a powder feedstock at step S120 including stainless steel and ceramic is bonded to an aluminum substrate to form a lightweight brake disc, using a processing method at a temperature T2 that is lower than the sintering temperature T1 used to manufacture the wear body.

The bonding method may be important in controlling material properties, with certain methods offering improved economics or material properties. Sintering is attractive as it may allow the use of similar equipment as the equipment used to form the wear body in the initial sintering step.

In example embodiments, the bonding step includes a sintering process. In other example embodiments, the sintering step to bond the wear body to the aluminum substrate is performed using spark plasma sintering (SPS). This process may be referred to as field assisted sintering (FAST) or direct current sintering (DCS). In example embodiments, the SPS process may include additional secondary heating methods. In example embodiments, using the SPS process instead of other sintering processes provides an advantage in, e.g., improving the sintering of aluminum by more easily breaking down the Al₂O₃ oxide film that naturally forms on bare Aluminum surfaces. Using the SPS process instead of other sintering processes also provides the advantage of lower processing times, the ability to achieve a higher density with a broader parameter set (i.e., more easily industrialized), and more uniform heating throughout the component, which results in improved mechanical properties.

In order to ensure an acceptable level of bonding between the wear body and substrate, a range of acceptable processing pressures may be used. In example embodiments, the sintering step to bond the wear body to the substrate is conducted at a pressure between 10 MPa and 100 MPa. In other example embodiments, the sintering is conducted at a pressure between 10 MPa and 80 MPa. In further example embodiments, the sintering is conducted at a pressure between 25 MPa and 75 MPa. In still further example embodiments, the sintering is conducted at a pressure between 25 MPa and 60 MPa. In other example embodiments, the sintering is conducted at a pressure between 5 MPa and 25 MPa.

In order to ensure good bonding between the wear body and substrate, a range of acceptable processing temperatures may be used. In other example embodiments, the sintering step to bond the wear body to the substrate is conducted at a temperature T2 that is greater than 50° C. and less than 650° C. In further example embodiments, the sintering step to bond the wear body to the substrate is conducted at a temperature T2 that is below 625° C. and greater than 50° C. In still further example embodiments, the sintering step to bond the wear body to the substrate is conducted at a temperature T2 that is below 600° C. and greater than 50° C. In other example embodiments, the sintering step to bond the wear body to the substrate is conducted at a temperature T2 that is below 575° C. and greater than 50° C.

In order to ensure an acceptable level of bonding between the wear body and substrate as well as to control process costs, the sintering time may be limited. In example embodiments, the sintering process to bond the wear body to the substrate may be conducted for a period of time that is less than 20 minutes. In example embodiments, when the sintering process takes more than 20 minutes, the process becomes expensive and thus less desirable.

When bonding the substrate to the wear body, an aluminide layer may form as a reaction between the two components. An excessively thick aluminide layer may reduce the mechanical properties of the brake disc. As a result, in example embodiments it is important to minimize the thickness of the aluminide reaction layer. In other example embodiments, the aluminide layer is less than 50 μm thick. In further example embodiments, the aluminide layer is less than 30 μm thick. In still further example embodiments, the aluminide layer is less than 20 μm thick. In example embodiments, the aluminide layer is less than 15 μm thick. In example embodiments, the aluminide layer is less than 10 μm thick. In example embodiments, when the thickness of the aluminide layer is greater than 50 μm, the aluminide layer may under undesirable embrittlement.

In example embodiments, the bonding step joining the wear body to the substrate is a brazing method. In other example embodiments, the bonding step joining the wear body to the substrate is a friction welding method. In further example embodiments, the bonding step joining the wear body to the substrate uses an adhesive.

In example embodiments, the surface of the wear body to be bonded to the aluminum substrate and/or of the aluminum substrate may be further processed to improve bonding. In other example embodiments, the surface is grit-blasted before bonding. In further example embodiments, the surface is ground before bonding. In example embodiments, the surface is polished before bonding. In still further example embodiments, the substrate is grit-blasted before bonding. In other example embodiments, the substrate is ground before bonding. In example embodiments, the substrate is polished before bonding.

In example embodiments of this disclosure, the aluminum substrate includes an alloy of aluminum. In other example embodiments, the alloy may be of the 6xxx type such as 6061 or similar. In further example embodiments, the component may be further heat treated after the wear body is bonded to the substrate to relieve stresses and/or improve mechanical properties.

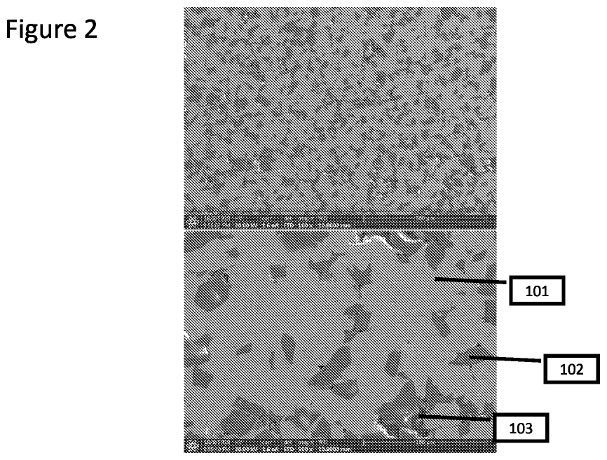

FIG. 2 is a SEM micrograph of a ferritic stainless steel according to an example embodiment. In FIG. 2 the SEM micrograph illustrates a ferritic stainless steel, designated by the label 101, having greater than 17 wt % Cr and an Al₂O₃/TiO₂ ceramic, designated by the label 102, and sintered via spark plasma sintering (SPS) at 1000° C. and 40 MPa for 10 min. The SEM micrograph shows a high density with minimal porosity, designated by the label 103.

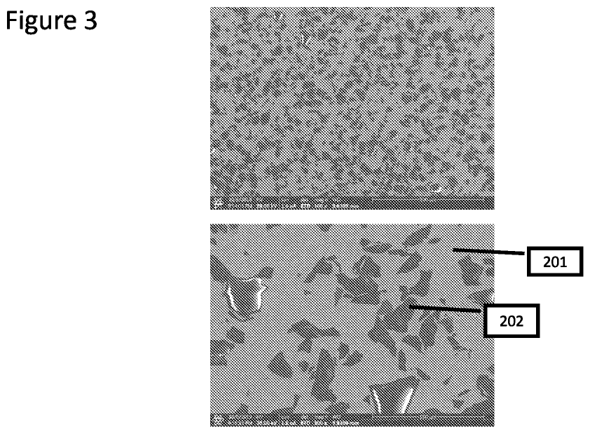

FIG. 3 is a SEM micrograph of a ferritic stainless steel according to another example embodiment. In FIG. 3, the SEM micrograph illustrates a ferritic stainless steel, designated by the label 201, having greater than 17 wt % Cr and an Al₂O₃/TiO₂ ceramic, designated by the label 202, and sintered via SPS at 1150° C. and 40 MPa for 10 min. The SEM micrograph shows a high density with no visible porosity.

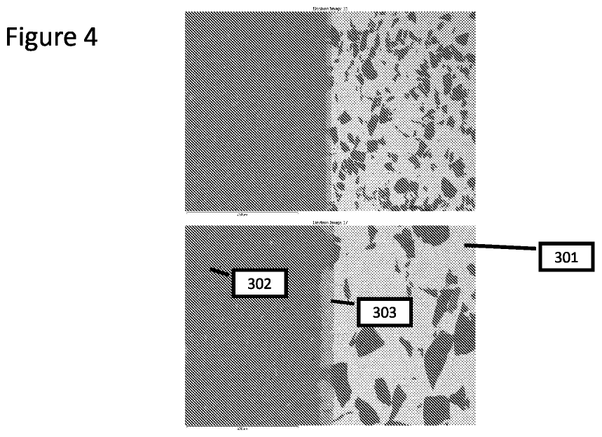

FIG. 4 is a SEM micrograph of a wear body according to an example embodiment. In FIG. 4, the SEM micrograph illustrates a wear body, designated by the label 301, bonded to an aluminum substrate designated by the label 302 via SPS sintering at 570° C. and 15 MPa for 10 min following polishing of both the substrate and the wear body. The aluminide layer that is formed, designated by the label 303, is less than 20 μm thick.

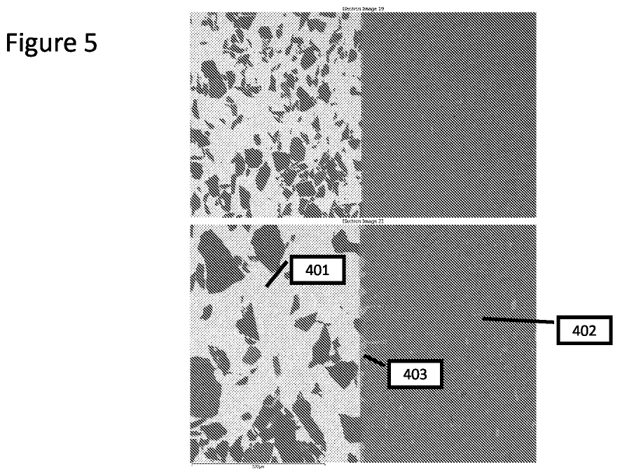

FIG. 5 is a SEM micrograph of a wear body according to another example embodiment. In FIG. 5, the SEM micrograph illustrates a wear body, designated by the label 401, bonded to an aluminum substrate designated by the label 402, via SPS sintering at 570° C. and 15 MPa for 10 min following grinding of both substrate and wear body. The aluminide layer that is formed, designated by the label 403, is less than 10 μm thick.

### 2. Applications for Use

The method of manufacture described in this patent may be used for, e.g., passenger vehicle braking systems, braking systems for motorized or non-motorized vehicles. For example, the discs may be used for front braking systems.

Although the present specification describes components and functions that may be implemented in example embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of the entirety of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

What is claimed:

1. A method of manufacturing a corrosion- and wear-resistant component, the method comprising:
preparing a feedstock powder that includes a stainless steel powder and a ceramic powder;
sintering the feedstock powder at a first temperature to form a low porosity free-standing wear body; and
bonding the wear body to an aluminum or aluminum alloy substrate at a second temperature lower than the first temperature.

2. The method of claim 1, wherein the feedstock powder is prepared using a spray drying process to form agglomerated powder particles containing the stainless steel and the ceramic.

3. The method of claim 1, wherein the feedstock powder is prepared via atomization, and wherein the ceramic phases precipitate during solidification or are injected prior to solidification.

4. The method of claim 1, wherein the feedstock powder comprises between 10 vol % and 60 vol % ceramic with a D50 particle size between 5 and 40 μm.

5. The method of claim 1, wherein the first temperature is greater than 900° C.

6. The method of claim 5, wherein the sintering comprises Spark Plasma Sintering, Field Assisted Sintering, or Direct Current Sintering.

7. The method of claim 1, wherein the second temperature is below 650° C.

8. The method of claim 1, wherein the stainless steel powder comprises ferritic stainless steel having a pitting resistance equivalent number (PREN) that is greater than or equal to 15, PREN being defined as, in wt %, Cr+3.3(Mo+0.5*W)+16*N.

9. The method of claim 1, wherein the ceramic powder comprises more than 80 wt % Al₂O₃.

10. The method of claim 1, wherein the stainless steel powder comprises a microstructure with greater than 90 vol % ferrite, wherein the stainless steel powder comprises less than 0.5 wt % Nickel, and wherein the feedstock powder comprises less than 15 wt % Aluminum.

11. The method of claim 1, wherein the ceramic powder constitutes between 15 and 60 vol % of the free-standing wear body.

12. The method of claim 1, wherein the free-standing wear body has less than 5 vol % porosity after the bonding.

13. The method of claim 1, wherein the free-standing wear body is bonded to the aluminum or aluminum alloy substrate by a metallurgical bond.

14. The method of claim 1, wherein, in bonding the wear body to the substrate, an aluminide layer is formed between the wear body and substrate, and wherein the aluminide layer is less than 25 μm thick.

15. A component manufactured by the method according to claim 1, wherein the component comprises a brake disc of a motorized or of a non-motorized vehicle.
